(19) United States
(12) Patent Application Publication
(10) Pub. No.: US 2026/0112967 A1
(43) Pub. Date: Apr. 23, 2026

(54) CHARGE PUMP FOR GATE DRIVER CIRCUIT

(71) Applicant: TEXAS INSTRUMENTS INCORPORATED, Dallas, TX (US)

(72) Inventors: Reza Sharifi, Sunnyvale, CA (US); Ramesh Balan, San Jose, CA (US)

(21) Appl. No.: 18/918,148

(22) Filed: Oct. 17, 2024

(51) Int. Cl. H02M 3/07; H02M 1/08

(52) U.S. Cl. CPC H02M 3/07; H02M 1/08

(57) ABSTRACT

Described embodiments include a charge pump circuit having first and second phase circuits. The first phase circuit is activated during a first operational cycle and inactivated during a second operational cycle. The second phase circuit is activated during the second operational cycle and inactivated during the first operational cycle. A first switch closes in response to the first phase circuit being activated and a first charge pump mode being selected. A second switch closes in response to the first phase circuit being activated and a second charge pump mode being selected. A third switch closes in response to the second phase circuit being activated and the first charge pump mode being selected. A fourth switch closes in response to the second phase circuit being activated and the second charge pump mode being selected.

### BACKGROUND

This description relates to charge pump circuits such as the circuits that may be used to provide power to gate driver circuits. Gate driver circuits can be used to control power switches in circuits such as power converters and motor drivers. One example of a power converter is a hybrid power converter. A hybrid power converter usually either cascades a switching converter circuit with a charge pump circuit, or cascades two different types of power converter circuits in series.

Charge pump switched capacitor circuits receive an input voltage and scale the voltage down by a conversion ratio. A typical charge pump circuit may have a conversion ratio of 2:1, but higher conversion ratio charge pumps are possible. A higher conversion ratio switched capacitor converter usually has multiple floating gate drivers. Each of these gate drivers typically use a dedicated external floating boot capacitor and an internal hold capacitor to drive the power switches, which can increase the silicon die area and the cost of the circuit.

### SUMMARY

In a first example, a charge pump circuit includes a first phase circuit having a first power input and a first power output. The first phase circuit is activated during a first operational cycle and inactivated during a second operational cycle. A second phase circuit has a second power input and a second power output. The second power output is coupled to the first power output. The second phase circuit is activated during the second operational cycle and inactivated during the first operational cycle.

A first switch has first and second switch terminals and a first switch control terminal. The first switch is configured to be closed in response to the first phase circuit being activated and a first charge pump mode being selected. A second switch has third and fourth switch terminals and a second switch control terminal. The fourth switch terminal is coupled to the second switch terminal. The second switch is configured to be closed in response to the first phase circuit being activated and a second charge pump mode being selected.

A third switch has fifth and sixth switch terminals and a third switch control terminal. The third switch is configured to be closed in response to the second phase circuit being activated and the first charge pump mode being selected. A fourth switch has seventh and eighth switch terminals and a fourth switch control terminal. The eighth switch terminal is coupled to the sixth switch terminal. The fourth switch is configured to be closed in response to the second phase circuit being activated and the second charge pump mode being selected.

In a second example, a two-phase charge pump circuit includes a first switch having first and second switch terminals and a first switch control terminal. The first switch is configured to be closed in response to a first operational phase being selected and a first charge pump mode being selected. A second switch has third and fourth switch terminals and a second switch control terminal. The fourth switch terminal is coupled to the second switch terminal. The second switch is configured to be closed in response to the first operational phase being selected and a second charge pump mode being selected.

A third switch has fifth and sixth switch terminals and a third switch control terminal. The third switch is configured to be closed in response to a second operational phase being selected and the first charge pump mode being selected. A fourth switch has seventh and eighth switch terminals and a fourth switch control terminal. The eighth switch terminal is coupled to the sixth switch terminal. The fourth switch is configured to be closed in response to the second operational phase being selected and the second charge pump mode being selected.

### BRIEF DESCRIPTION OF THE DRAWINGS

FIG. 1 shows a schematic diagram for an example dual-phase 3:1 charge pump circuit.

FIG. 2 shows a schematic and timing diagram for a first example dual-phase boot capacitor charge circuit and method for charging a boot capacitor.

FIG. 3 shows a schematic and timing diagram for a second example dual-phase boot capacitor charge circuit and method for charging a boot capacitor.

FIG. 4 shows a schematic diagram for an example dual-phase charge pump circuit without floating capacitors.

FIG. 5 shows a schematic diagram for an example dual-phase boot capacitor charge circuit and its control for powering gate driver circuits.

FIG. 6 shows a schematic diagram for an example single-phase boot capacitor charge circuit for powering gate driver circuits.

FIG. 7 shows a schematic diagram for an example auxiliary charge pump circuit useful in single-phase boot capacitor charge circuits.

### DETAILED DESCRIPTION

In this description, the same reference numbers depict same or similar (by function and/or structure) features. The drawings are not necessarily drawn to scale.

Battery charger applications often include a hybrid power converter. Hybrid power converters are typically expected to deliver a specified power at a specified voltage with at least a minimum efficiency while meeting area and cost specifications. A hybrid power converter usually either cascades a switching converter with a charge pump circuit, or cascades two different types of power converters in series. Charge pump switched capacitor circuits receive an input voltage and scale the input voltage down by a conversion ratio. A typical charge pump circuit may have a conversion ratio of 2:1, but higher conversion ratio charge pumps are possible (e.g. 3:1).

A 3:1 charge pump provides an output voltage that is one-third of its input voltage, and provides an output current that is three times its input current. As the charge pump ratio increases, the current through the inductor decreases, which reduces energy loss through the inductor core, resulting in higher power efficiency.

However, the design of the charge pump gate driver becomes more complicated as the conversion ratio increases due to the multiple floating gate drivers that each require an individual power supply for each gate driver. As the conversion ratio increases, the number of switches increases, and powering the gate drivers for those switches becomes more complex and requires more area, increasing the cost.

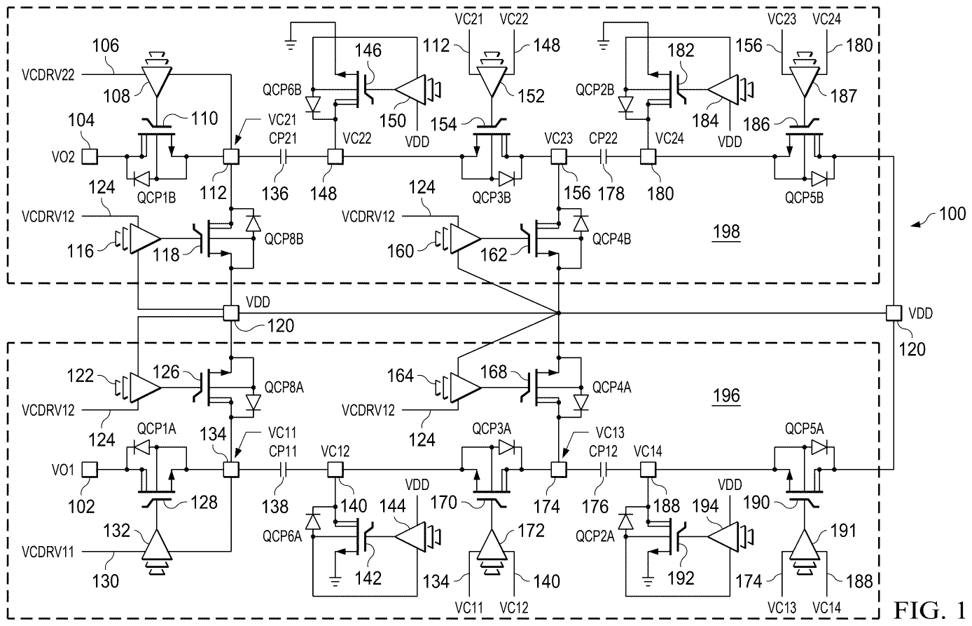

FIG. 1 shows a schematic diagram for an example dual-phase 3:1 charge pump circuit 100. This circuit uses external floating boot capacitors to provide power to the floating gate drivers that drive power switches. Each power switch in the circuit is controlled by a signal from a gate driver. Each of those gate drivers receives its power from a boot capacitor. However, not all the switches are at the same voltage. Different voltages are required to charge the different boot capacitors and enable the gate drivers to turn on and turn off the switches.

Terminals 102 and 104 comprise a differential input from a voltage regulator circuit (not shown), and provide voltages VO1 and VO2, respectively. Transistors QCP1A 128, QCP8A 126, QCP6A 142, QCP3A 170, QCP4A 168, QCP2A 192 and QCP5A 190 make up the A phase 196 of dual-phase charge pump circuit 100. Transistors QCP1B 128, QCP8B 126, QCP6B 142, QCP3B 170, QCP4B 168, QCP2B 192 and QCP5B 190 make up the B phase 198 of dual-phase charge pump circuit 100.

Transistor QCP1A 128 is coupled between terminal 102 and terminal VC11 134, and has a control terminal coupled to the output of gate driver 132. Gate driver 132 is powered by voltage source VCDRV11 130. Transistor QCP8A 126 is coupled between output voltage terminal VDD 120 and terminal VC11 134, and has a control terminal coupled to the output of gate driver 122. Gate driver 122 is powered by voltage source VCDRV12 124.

Capacitor CP11 138 is coupled between terminal VC11 134 and terminal VC12 140. Transistor QCP6A 142 is coupled between terminal VC12 140 and a ground terminal, and has a control terminal coupled to the output of gate driver 144. Gate driver 144 is powered by output voltage terminal VDD 120. Transistor QCP3A 170 is coupled between terminal VC12 140 and terminal VC13 174, and has a control terminal coupled to the output of gate driver 172. Gate driver 172 is powered by VC11 134, and is referenced to VC12 140.

Capacitor CP12 176 is coupled between terminal VC13 174 and terminal VC14 188. Transistor QCP4A 168 is coupled between terminal VC13 174 and the output voltage terminal VDD 120, and has a control terminal coupled to the output of gate driver 164. Gate driver 164 is powered by voltage source VCDRV12 124. Transistor QCP2A 192 is coupled between terminal VC14 188 and the ground terminal, and has a control terminal coupled to the output of gate driver 194. Gate driver 194 is powered by output voltage terminal VDD 120. Transistor QCP5A 190 is coupled between terminal VC14 188 and the output voltage terminal VDD 120 and has a control terminal coupled to the output of gate driver 191. Gate driver 191 is powered by VC13 174, and is referenced to VC14 188.

Transistor QCP1B 110 is coupled between terminal 104 and terminal VC21 112, and has a control terminal coupled to the output of gate driver 108. Gate driver 108 is powered by voltage source VCDRV21 112. Transistor QCP8B 118 is coupled between output voltage terminal VDD 120 and terminal VC21 112, and has a control terminal coupled to the output of gate driver 116. Gate driver 116 is powered by voltage source VCDRV12 124.

Capacitor CP21 136 is coupled between terminal VC21 112 and terminal VC22 148. Transistor QCP6B 146 is coupled between terminal VC22 148 and the ground terminal, and has a control terminal coupled to the output of gate driver 150. Gate driver 150 is powered by output voltage terminal VDD 120. Transistor QCP3B 154 is coupled between terminal VC22 148 and terminal VC23 156, and has a control terminal coupled to the output of gate driver 152. Gate driver 152 is powered by VC21 112, and is referenced to VC22 148.

Capacitor CP22 178 is coupled between terminal VC23 156 and terminal VC24 180. Transistor QCP4B 162 is coupled between terminal VC23 156 and the output voltage terminal VDD 120, and has a control terminal coupled to the output of gate driver 160. Gate driver 160 is powered by voltage source VCDRV12 124. Transistor QCP2B 182 is coupled between terminal VC24 180 and the ground terminal, and has a control terminal coupled to the output of gate driver 184. Gate driver 184 is powered by output voltage terminal VDD 120. Transistor QCP5B 186 is coupled between terminal VC24 180 and the output voltage terminal VDD 120 and has a control terminal coupled to the output of gate driver 187. Gate driver 187 is powered by VC23 156, and is referenced to VC24 180.

Transistor QCP6A 142 and QCP2A 192 are each referenced to ground through each of their respective source terminals. A voltage of 5V or more above ground applied to their respective gate terminals turns on transistors QCP6A 142 and QCP2A 192, respectively. This voltage can be provided by the output voltage terminal VDD 120. So, gate driver 144 and gate driver 194 are each powered by the output voltage terminal VDD 120.

The source terminal of transistor QCP3A 170 is connected to terminal VC12 140, and the source terminal of QCP5A 190 is connected to terminal VC14 188. So, a voltage higher than the voltage at terminal VC12 140 is required for powering gate driver 172 to turn on transistor QCP3A 170, and a voltage higher than the voltage at terminal VC14 188 is required for powering gate driver 191 to turn on transistor QCP5A 190. When transistor QCP8A 126 and transistor QCP5A 190 are each turned on, the voltage across capacitor CP11 138 is VDD. So, terminal VC11 134 can be used to power gate driver 172 to control transistor QCP3A 170, and terminal VC12 140 can be used as the reference voltage for gate driver 172. Terminal VC13 174 can be used to power gate driver 191 to control transistor QCP5A 190, and terminal VC14 188 can be used as the reference voltage for gate driver 191.

To turn on transistor QCP4A 168, the supply voltage for gate driver 164 must be 5V higher than VDD 120. To turn on transistor QCP8A 126, the supply voltage for gate driver 122 must be 5V higher than VDD 120. To turn on transistor QCP1A 128, the supply voltage for gate driver 132 needs to be 5V higher than the voltage at terminal VC11 134. A dedicated boot capacitor is needed to provide power to each of the gate drivers. Each boot capacitor needs to be periodically recharged when transistor QCP1A 128 is not turned on.

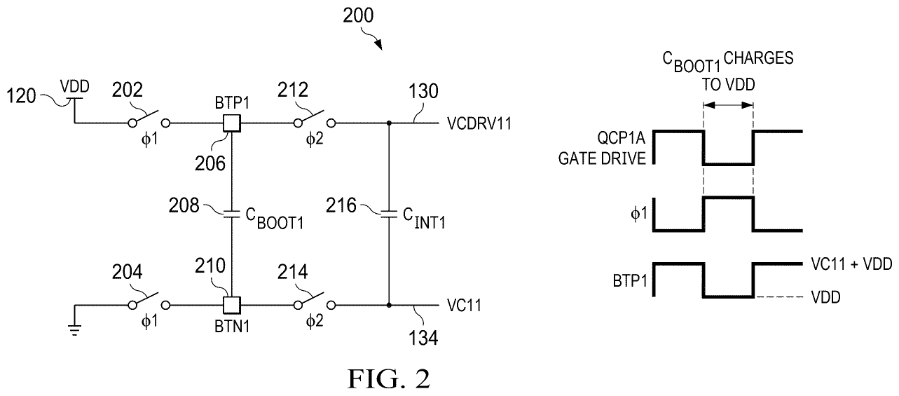

FIG. 2 shows a schematic and timing diagram for a first example dual-phase boot capacitor charge circuit 200, and a method for charging a boot capacitor. A first signal Φ1 controls switches 202 and 204. A second signal Φ2 controls switches 212 and 214, where Φ2 has the inverse polarity of Φ1. Switch 202 is coupled between the output voltage terminal VDD 120 and terminal BTP1 206. Switch 204 is coupled between terminal BTN1 210 and the ground terminal. Boot capacitor C_{BOOT1} 208 is coupled between terminal BTP1 206 and terminal BTN1 210. Switch 212 is coupled between terminal BTP1 206 and VCDRV11 130. Switch 214 is coupled between terminal BTN1 210 and VC11 134. Capacitor C_{INT1} 216 is coupled between VCDRV11 130 and terminal VC11 134.

When Φ1 is high, then Φ2 is low. So, when switches 202 and 204 are closed, switches 212 and 214 are open. When switches 202 and 204 are open, switches 212 and 214 are closed. When switches 202 and 204 are closed and switches 212 and 214 are open, boot capacitor C_{BOOT1} 208 is charged to the voltage at the output voltage terminal VDD 120. When Φ1 turns switches 202 and 204 off and Φ2 turns switches 212 and 214 on, transistor QCP1A 128 is turned on, connecting capacitor C_{BOOT1} 208 between terminal VC11 134 and VCDRV11 130. This provides a voltage at VCDRV11 130 that is 5V higher than the voltage at terminal VC11 134 because the boot capacitor C_{BOOT1} 208 that is charged to 5V is then connected between those two terminals.

Gate driver 108 for transistor QCP1B 110 needs its own dedicated boot capacitor because it cannot use the boot capacitor C_{BOOT1} 208 that supplies gate driver 132 for transistor QCP1A 128. Gate driver 122 for transistor QCP8A 126 and gate driver 150 for transistor QCP8B 146 each need an additional respective boot capacitor for their supply voltage because transistors QCP8A and QCP8B are complementary to each other.

In the configuration of dual-phase boot capacitor charge circuit 200, turning on the transistor requires a voltage 5V higher than its reference voltage, and the boot capacitor is recharged while the transistor is turned off. A total of three external floating boot capacitors, three additional internal capacitors, and six bond pad terminals are needed for operation of dual-phase boot capacitor charge circuit 200. These additional capacitors and the circuitry associated with them add a significant amount of area and cost to the circuit.

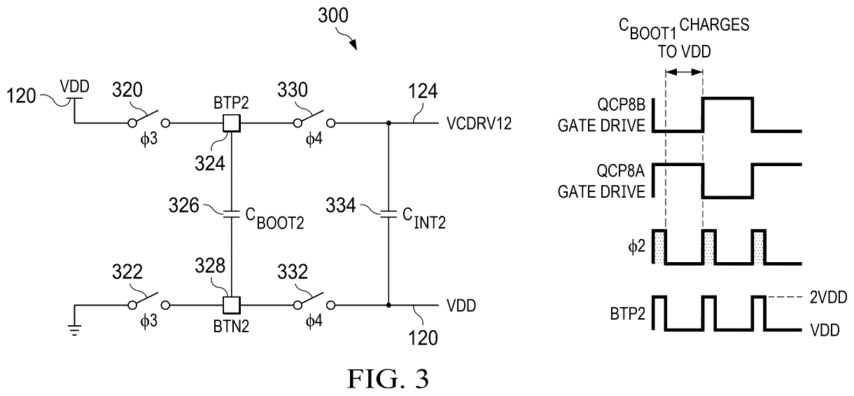

FIG. 3 shows a schematic and timing diagram for a second example dual-phase boot capacitor charge circuit 300 and method for charging a boot capacitor. A first signal Φ3 controls switches 320 and 322. A second signal Φ4 controls switches 330 and 332, where Φ4 has the inverse polarity of Φ3. Switch 320 is coupled between the output voltage terminal VDD 120 and terminal BTP2 324. Switch 322 is coupled between terminal BTN2 328 and the ground terminal. Boot capacitor C_{BOOT2} 326 is coupled between BTP2 324 and BTN2 328. Switch 330 is coupled between BTP2 324 and VCDRV12 124. Switch 332 is coupled between terminal BTN2 328 and the output voltage terminal VDD 120. Capacitor C_{INT2} 334 is coupled between VCDRV12 124 and the output voltage terminal VDD 120.

When Φ3 is high, Φ4 is low. So, when switches 320 and 322 are closed, switches 330 and 332 are open. When switches 320 and 322 are open, switches 330 and 332 are closed. While switches 320 and 322 are closed and switches 330 and 332 are open, boot capacitor C_{BOOT2} 326 is charged to the voltage of the output voltage terminal VDD 120. When Φ3 turns switches 320 and 322 off and Φ4 turns switches 330 and 332 on, transistor QCP8A is turned on, connecting capacitor C_{BOOT2} 326 between terminal VCDRV12 124 and the output voltage terminal VDD 120. This provides a voltage at VCDRV12 124 that is 5V higher than the voltage at the output voltage terminal VDD 120 because the boot capacitor C_{BOOT2} 326 that is charged to 5V is then connected between VCDRV12 124 and the output voltage terminal VDD 120.

The rising edges and falling edges of the gate drive signal for transistors QCP8A 126 and QCP8B 118 are detected and generate the signal Φ2. When a transition occurs, the boot capacitor C_{BOOT2} 326 is connected across the gate driver. When the transition is completed, the boot capacitor C_{BOOT2} 326 is disconnected and recharged to the voltage of VDD. When the transition occurs and Φ2 goes high, the boot capacitor C_{BOOT2} 326 is connected across the gate driver by closing switches 330 and 332 and opening switches 320 and 322.

The transition completes during the time between pulses and the boot capacitor C_{BOOT2} 326 is disconnected from the gate driver. Boot capacitor C_{BOOT2} 326 is then recharged to a voltage of VDD by opening switches 330 and 332 and closing switches 320 and 322. In the configuration of dual-phase boot capacitor charge circuit 300, one boot capacitor is sufficient to power the respective gate drivers for transistors QCP8A 126, QCP8B 118, QCP4A 168, and QCP4B 162. This is because QCP8A 126 and QCP8B 118 are complementary to each other and share a common source connection. Transistors QCP1A 128 and QCP1B 110 still each need an individual boot capacitor because terminal VC21 112 and terminal VC11 134 are at different voltages. So, three boot capacitors are needed for operation according to dual-phase boot capacitor charge circuit 300, which requires a considerable amount of area and a corresponding cost.

The configuration of dual-phase boot capacitor charge circuit 200 requires four floating boot capacitors, and the configuration of dual-phase boot capacitor charge circuit 300 requires three floating boot capacitors. Each of those floating boot capacitors usually requires two external package connections. So, either six external package connections for the configuration of dual-phase boot capacitor charge circuit 200 or eight external package connections for the configuration of dual-phase boot capacitor charge circuit 300 may be needed, each external package connection adding more area and cost to the circuit.

Another potential issue with the configurations of dual-phase boot capacitor charge circuit 200 and dual-phase boot capacitor charge circuit 300 is that when the boot capacitor is disconnected, the voltage across the gate driver will not sustain itself and needs to be held. So, capacitors C_{INT1} 216 and C_{INT2} 334 are added to hold the voltage across the gate driver, which adds more area and cost. Each transistor needs its own internal capacitor (e.g. C_{INT1} 216, C_{INT2} 334), significantly increasing the area and cost with each additional transistor.

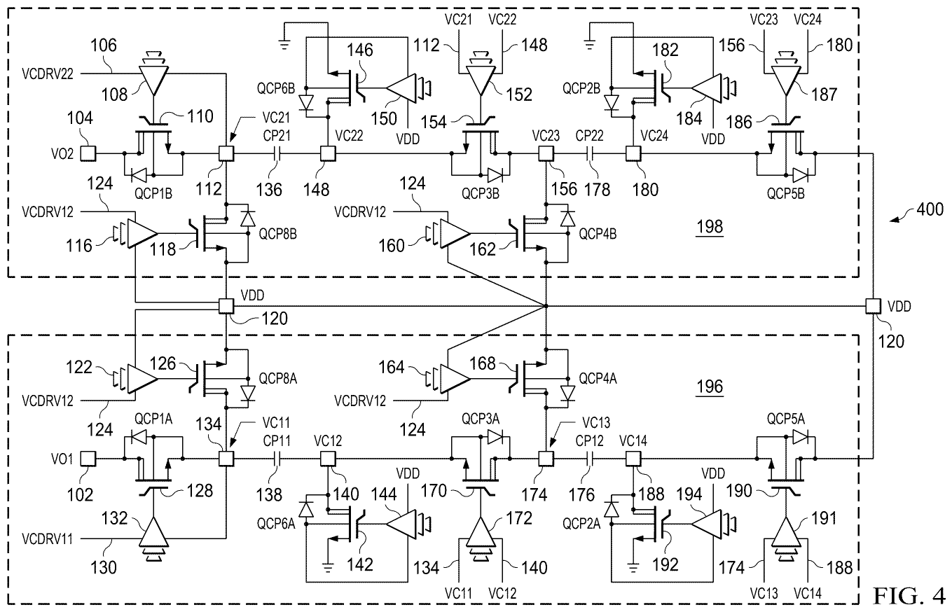

FIG. 4 shows a schematic diagram for an example dual-phase charge pump circuit 400 without floating capacitors. Terminals 102 and 104 comprise a differential input from a voltage regulator circuit (not shown), and provide voltages VO1 and VO2, respectively. Transistors QCP1A 128, QCP8A 126, QCP6A 142, QCP3A 170, QCP4A 168, QCP2A 192 and QCP5A 190 make up the A phase 196 of dual-phase charge pump circuit 400. Transistors QCP1B 128, QCP8B 126, QCP6B 142, QCP3B 170, QCP4B 168, QCP2B 192 and QCP5B 190 make up the B phase 198 of dual-phase charge pump circuit 400.

Transistor QCP1A 128 is coupled between terminal 102 and terminal VC11 134, and has a control terminal coupled to the output of gate driver 132. Gate driver 132 is powered by voltage source VCDRV11 130. Transistor QCP8A 126 is coupled between output voltage terminal VDD 120 and terminal VC11 134, and has a control terminal coupled to the output of gate driver 122. Gate driver 122 is powered by voltage source VCDRV12 124.

Capacitor CP11 138 is coupled between terminal VC11 134 and terminal VC12 140. Transistor QCP6A 142 is coupled between terminal VC12 140 and a ground terminal, and has a control terminal coupled to the output of gate driver 144. Gate driver 144 is powered by output voltage terminal VDD 120. Transistor QCP3A 170 is coupled between terminal VC12 140 and terminal VC13 174, and has a control terminal coupled to the output of gate driver 172. Gate driver 172 is powered by VC11 134 and is referenced to VC12 140.

Capacitor CP12 176 is coupled between terminal VC13 174 and terminal VC14 188. Transistor QCP4A 168 is coupled between terminal VC13 174 and the output voltage terminal VDD 120, and has a control terminal coupled to the output of gate driver 164. Gate driver 164 is powered by voltage source VCDRV12 124. Transistor QCP2A 192 is coupled between terminal VC14 188 and the ground terminal, and has a control terminal coupled to the output of gate driver 194. Gate driver 194 is powered by output voltage terminal VDD 120. Transistor QCP5A 190 is coupled between terminal VC14 188 and the output voltage terminal VDD 120 and has a control terminal coupled to the output of gate driver 191. Gate driver 191 is powered by terminal VC13 174, and is referenced to terminal VC14 188.

Transistor QCP1B 110 is coupled between terminal 104 and terminal VC21 112, and has a control terminal coupled to the output of gate driver 108. Gate driver 108 is powered by voltage source VCDRV21 112. Transistor QCP8B 118 is coupled between output voltage terminal VDD 120 and terminal VC21 112, and has a control terminal coupled to the output of gate driver 116. Gate driver 116 is powered by voltage source VCDRV12 124.

Capacitor CP21 136 is coupled between terminal VC21 112 and terminal VC22 148. Transistor QCP6B 146 is coupled between terminal VC22 148 and the ground terminal, and has a control terminal coupled to the output of gate driver 150. Gate driver 150 is powered by output voltage terminal VDD 120. Transistor QCP3B 154 is coupled between terminal VC22 148 and terminal VC23 156, and has a control terminal coupled to the output of gate driver 152. Gate driver 152 is powered by terminal VC21 112, and is referenced to terminal VC22 148.

Capacitor CP22 178 is coupled between terminal VC23 156 and terminal VC24 180. Transistor QCP4B 162 is coupled between terminal VC23 156 and the output voltage terminal VDD 120, and has a control terminal coupled to the output of gate driver 160. Gate driver 160 is powered by voltage source VCDRV12 124. Transistor QCP2B 182 is coupled between terminal VC24 180 and the ground terminal, and has a control terminal coupled to the output of gate driver 184. Gate driver 184 is powered by output voltage terminal VDD 120. Transistor QCP5B 186 is coupled between terminal VC24 180 and the output voltage terminal VDD 120, and has a control terminal coupled to the output of gate driver 187. Gate driver 187 is powered by terminal VC23 156, and is referenced to terminal VC24 180.

Transistor QCP6A 142 and QCP2A 192 are each referenced to ground through their respective source terminals. A voltage of 5V or more above ground applied to their respective gate terminals will turn on transistor QCP6A 142 and QCP2A 192, respectively. This voltage is provided by the output voltage terminal VDD 120. So, gate driver 144 and gate driver 194 are each powered by the output voltage terminal VDD 120.

The source terminal of transistor QCP3A 170 is connected to terminal VC12 140, and the source terminal of QCP5A 190 is connected to terminal VC14 188. So, a voltage higher than the voltage at terminal VC12 140 is required for powering gate driver 172 to turn on transistor QCP3A 170, and a voltage higher than the voltage at terminal VC14 188 is required for powering gate driver 191 to turn on transistor QCP5A. When transistor QCP8A 126 and transistor QCP5A 190 are each turned on, the voltage across capacitor CP11 is VDD. So, terminal VC11 134 can be used to power gate driver 172 to control transistor QCP3A 170, and VC12 140 can be used as the reference voltage for gate driver 172. Terminal VC13 174 can be used to power gate driver 191 to control transistor QCP5A 190, and terminal VC14 188 can be used as the reference voltage for gate driver 191.

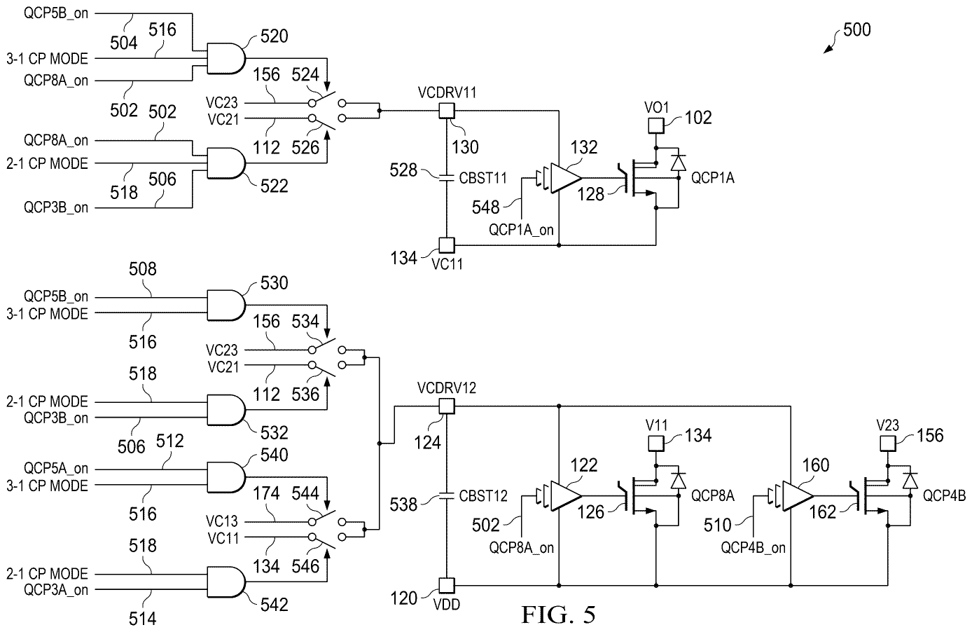

FIG. 5 shows a schematic diagram for an example dual-phase boot capacitor charge circuit 500 and its control for powering gate driver circuits. AND gate 520 has first, second, and third inputs. The first input of AND gate 520 receives a control signal QCP5B_on 504, which controls gate driver 187 for transistor QCP5B 186. The second input of AND gate 520 receives a 3:1 CP mode signal 516, which is asserted when dual-phase charge pump circuit 400 is operating in 3:1 mode. The third input of AND gate 520 receives a control signal QCP8A_on 502, which controls gate driver 122 for transistor QCP8A 126. The output of AND gate 520 is coupled to the control terminal of switch 524. Switch 524 is coupled between VC23 156 and VCDRV11 130.

AND gate 522 has first, second, and third inputs. The first input of AND gate 522 receives the control signal QCP8A_on 504. The second input of AND gate 522 receives a 2:1 CP mode signal 518, which is asserted when dual-phase charge pump circuit 400 is operating in 2:1 mode. The third input of AND gate 522 receives a control signal QCP3B_on 506, which controls gate driver 152 for transistor QCP3B 154. The output of AND gate 522 is coupled to the control terminal of switch 526. Switch 526 is coupled between VC21 112 and VCDRV11 130.

AND gate 530 has first and second inputs. The first input of AND gate 530 receives the control signal QCP5B_on 508, which controls gate driver 187 for transistor QCP5A 186. The second input of AND gate 530 receives the 3:1 CP mode signal 516. The output of AND gate 530 controls switch 534. Switch 534 is coupled between VC23 156 and VCDRV12 124. AND gate 532 has first and second inputs. The first input of AND gate 532 receives the control signal QCP3B_on 506. The second input of AND gate 532 receives the 2:1 CP mode signal 518. The output of AND gate 532 controls switch 536. Switch 536 is coupled between VC21 112 and VCDRV12 124.

AND gate 540 has first and second inputs. The first input of AND gate 540 receives the control signal QCP5A_on 512, which controls gate driver 191 for transistor QCP5A 190. The second input of AND gate 540 receives the 3:1 CP mode signal 516. The output of AND gate 540 controls switch 544. Switch 544 is coupled between terminal VC13 174 and VCDRV12 124. AND gate 542 has first and second inputs. The first input of AND gate 542 receives the control signal QCP3A_on 514. The second input of AND gate 542 receives the 2:1 CP mode signal 518. The output of AND gate 542 controls switch 546. Switch 546 is coupled between terminal VC11 134 and VCDRV12 124.

Capacitor CBST11 528 is coupled between VCDRV11 130 and terminal VC11 134. VCDRV11 powers gate driver 132, and terminal VC11 provides a reference voltage for gate driver 132. The output of gate driver 132 is coupled to the gate of transistor QCP1A 128. Capacitor CBST12 538 is coupled between VCDRV12 124 and output voltage terminal VDD 120. VCDRV12 powers gate driver 122, and output voltage terminal VDD 120 provides a reference voltage for gate driver 122. The output of gate driver 122 is coupled to the gate of transistor QCP8A 126. VCDRV12 powers gate driver 160, and output voltage terminal VDD 120 provides a reference voltage for gate driver 160. The output of gate driver 160 is coupled to the gate of transistor QCP4B 162. VCDRV12 powers gate driver 116, and output voltage terminal VDD 120 provides a reference voltage for gate driver 116. The output of gate driver 116 is coupled to the gate of transistor QCP8B 118. VCDRV12 powers gate driver 164, and output voltage terminal VDD 120 provides a reference voltage for gate driver 164. The output of gate driver 164 is coupled to the gate of transistor QCP4A 168.

A first difference between dual-phase boot capacitor charge circuit 500 and dual-phase boot capacitor charge circuits 200 and 300 is that dual-phase boot capacitor charge circuit 500 does not use internal capacitors (e.g. C_{INT1} 216, C_{INT2} 334) to hold the voltage across the gate drivers. A second difference between dual-phase boot capacitor charge circuit 500 and dual-phase boot capacitor charge circuits 200 and 300 is that dual-phase boot capacitor charge circuit 500 does not use floating boot capacitors because one terminal of each boot capacitor is connected to the source terminal of a respective transistor. So, the voltage across the boot capacitor is always applied across the gate driver, eliminating the need for an internal capacitor to hold the voltage across the gate driver. Further, because the boot capacitor is connected to the reference voltage terminal, one external capacitor terminal that was previously used is no longer needed, reducing the external capacitor terminal count by half.

Removing the internal capacitors and reducing the external capacitor terminal count saves die area and cost, and the circuit is operable in both 3:1 charge pump mode and 2:1 charge pump mode. In a 3:1 charge pump mode, two flying capacitors are used in series as well as in parallel, so that the output voltage is one-third the input voltage, and the output current is three times the input current. In a 2:1 charge pump mode, capacitor CP12 176 and capacitor CP22 178 are not switched at all. Instead, capacitor CP11 138 or CP21 136 is switched in series and in parallel with the output voltage terminal VDD 120, but capacitor CP12 176 and capacitor CP22 178 remain connected in parallel with the output voltage terminal VDD 120. So, the output voltage is half the input voltage when operating in a 2:1 charge pump mode.

During the A phase in a 3:1 charge pump mode, transistors QCP1A 128, QCP3A 170 and QCP5A 190, QCP2B 182, QCP4B 146, QCP6B 146 and QCP8B 118 are turned on. The remaining transistors in dual-phase charge pump circuit 400 remain turned off, so that capacitor CP11 138 and capacitor CP12 176 are connected in series with the output voltage terminal VDD 120. If capacitor CP11 138 and capacitor CP12 176 each has a voltage of VDD across it, the input voltage is 3*VDD because each of the capacitors adds a voltage of VDD.

During the B phase in a 3:1 charge pump mode, transistors QCP1A 128, QCP3A 170 and QCP5A 190, QCP2B 182, QCP4B 146, QCP6B 146 and QCP8B 118 are turned off. The remaining transistors in dual-phase charge pump circuit 400 remain turned on, and capacitors CP11 138 and CP12 176 are recharged to a voltage of VDD. During the A phase, capacitors CP11 138 and CP12 176 are connected in parallel with the output and are charged to a voltage of VDD. During the B phase, capacitors CP11 138 and CP12 176 are connected in series with the output, so the output voltage is one-third the input voltage.

When transistors QCP1A 128, QCP 3A 170 and QCP 5A 190 are turned on, terminal VC11 134 is connected to input voltage source V01 102. The voltage at VC12 140 is equal to the voltage of V01 102 minus the voltage of VDD 120. If the voltage at V01 102 is equal to 3*VDD, then the voltage at terminal VC12 140 will be equal to 2*VDD. The voltage at terminal VC13 174 is equal to the voltage at terminal VC12 140 because transistor QCP3A 170 is turned on. So, the voltage at terminal VC12 140 is 2*VDD, and the voltage at terminal VC14 188 is equal to the voltage of VDD 120 plus the voltage at terminal VC13 174, or 3*VDD.

When transistors QCP1A 128, QCP3A 170 and QCP5A 190 are turned on, transistors QCP2B 182, QCP4B 146, QCP6B 146 and QCP8B 118 are turned on. So, the voltages at terminals VC21 112 and VC23 156 are equal to VDD, and terminals VC22 148 and VC24 180 are each shorted to ground. Terminal VC21 112 is connected to VDD 120, and terminal VC22 148 is connected to ground. To recharge the boot capacitor that is powering gate driver 108 for transistor QCP1B 110 requires a voltage equal to VDD plus the voltage at terminal VC21 112, or 2*VDD, which is the voltage at VC13 174. So, the voltage at terminal VC13 174 can be used to recharge the capacitor between VCDRV22 106 and terminal VC21 112. The voltage at terminal VC21 is at VDD, and the voltage at terminal VC22 is at ground.

While operating in 3:1 charge pump mode, if the transistors of the A phase 196 are connected in series and the transistors of the B phase 198 are connected in parallel, VCDRV22 106 is being charged from terminal VC13 174. When the transistors of the A phase 196 are connected in parallel and the transistors of the B phase 198 are connected in series, VCDRV11 130 is being charged from terminal VC23 156. When transistors QCP5B 186 and QCP8A 126 are turned on, B phase 198 is connected in series and A phase 196 is connected in parallel. During this time, terminal VC23 156 is connected to VCDRV11 130 through one switch, recharging terminal VC23 156 to the voltage of the boot capacitor between VCDRV11 130 and VC11 134.

VCDRV11 130 is coupled to switch 524 and to switch 526. However, only one of switch 524 and switch 526 will be closed at any given time. So, VCDRV11 130 will receive at most a single input to charge capacitor CBST11 528; one input when operating in 3:1 charge pump mode, and the other when operating in 2:1 charge pump mode. A single capacitor is used for both phase A and phase B. Similarly, VCDRV 12 124 is coupled to switches 534, 536, 544 and 546, but only one of those four switches will be closed at any given time.

So, VCDRV12 124 will receive at most a single input to charge capacitor CBST12 538. Switch 534 is closed during phase B when operating in 3:1 charge pump mode. Switch 544 is closed during phase A when operating in 3:1 charge pump mode. Switch 536 is closed during phase B when operating in 2:1 charge pump mode. Switch 546 is closed during phase A when operating in 2:1 charge pump mode.

Dual-phase charge pump circuit 400 can be changed from operating in a 3:1 charge pump mode to a 2:1 charge pump mode on the fly. It may be necessary to make that change because the charge pump circuit receives its input voltage from a separate voltage converter, and must regulate that input voltage it receives to a specified output voltage VDD. The input voltage can vary over a wide range, and having the flexibility to select operation in either a 3:1 charge pump mode or a 2:1 charge pump mode allows dual-phase charge pump circuit 400 to support a wider range of input voltages. In other examples, other charge pump ratios may be available.

When dual-phase charge pump circuit 400 is operating in a 2:1 charge pump mode, capacitors CP22 178 and CP12 176 do not switch between series connection and parallel connection. Instead, capacitor CP22 178 and CP12 176 are always connected to the output voltage terminal VDD 120. Transistors QCP4A 168, QCP4B 162, QCP2A 192 and QCP2B 182 are always turned on, and transistors QCP5A 190 and QCP5B 186 are always turned off when operating in the 2:1 charge pump mode. So, only capacitors CP11 138 and CP21 136 are connected in series or parallel with the output voltage terminal VDD 120, and they do not need to be charged in order to be at a voltage of 2*VDD.

When transistor QCP8A 126 is turned on, a voltage of 2*VDD is needed to charge capacitor CBST11 to power gate driver 132 for transistor QCP1A, CBST11, which it receives from terminal VC21 112. When transistors QCP8A 126 and QCP3B 154 are turned on, the A phase 196 is connected in parallel, and the B phase is connected in series. A voltage of 2*VDD is provided at VCDRV12 124 to charge capacitor CBST12, which is referenced to output voltage terminal VDD 120. A voltage of 2*VDD can be obtained by connecting to either terminal VC21 112 or terminal VC11 134, depending upon which switches are turned on.

Distinguishing characteristics of dual-phase charge pump circuit 400 include that the top plate of each capacitor is connected to the supply of a respective gate driver. The second distinguishing characteristic is that the need for internal capacitors to hold the voltage across the respective gate drivers is eliminated because the capacitor is always connected to the source terminal of the respective transistors, so the voltage across the boot capacitor is always available across the gate driver.

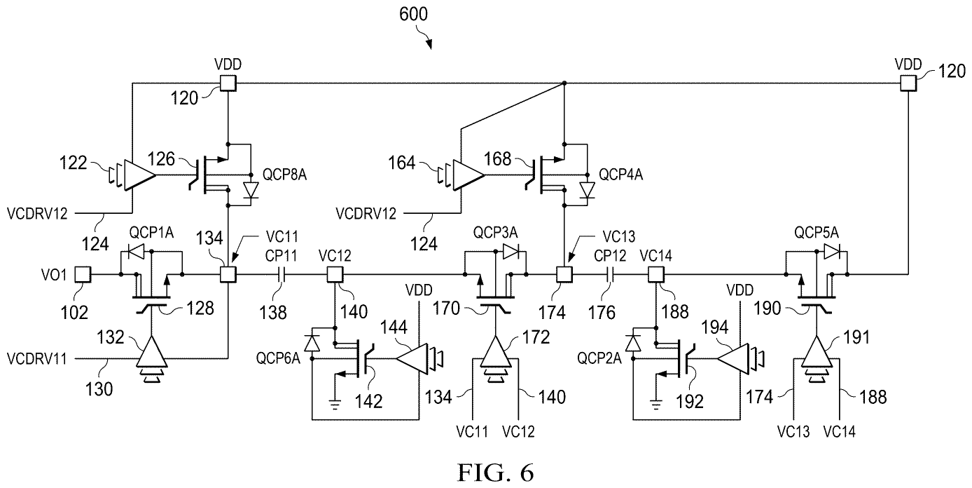

FIG. 6 shows a schematic diagram for an example single-phase boot capacitor charge circuit 600 for powering gate driver circuits. Transistor QCP1A 128 is coupled between terminal 102 and terminal VC11 134, and has a control terminal coupled to the output of gate driver 132. Gate driver 132 is powered by voltage source VCDRV11 130. Transistor QCP8A 126 is coupled between output voltage terminal VDD 120 and terminal VC11 134, and has a control terminal coupled to the output of gate driver 122. Gate driver 122 is powered by voltage source VCDRV12 124.

Capacitor CP11 138 is coupled between terminal VC11 134 and terminal VC12 140. Transistor QCP6A 142 is coupled between terminal VC12 140 and the ground terminal, and has a control terminal coupled to the output of gate driver 144. Gate driver 144 is powered by output voltage terminal VDD 120. Transistor QCP3A 170 is coupled between terminal VC12 140 and terminal VC13 174, and has a control terminal coupled to the output of gate driver 172. Gate driver 172 is powered by VC11 134, and is referenced to terminal VC12 140.

Capacitor CP12 176 is coupled between terminal VC13 174 and terminal VC14 188. Transistor QCP4A 168 is coupled between terminal VC13 174 and the output voltage terminal VDD 120, and has a control terminal coupled to the output of gate driver 164. Gate driver 164 is powered by voltage source VCDRV12 124. Transistor QCP2A 192 is coupled between terminal VC14 188 and the ground terminal, and has a control terminal coupled to the output of gate driver 194. Gate driver 194 is powered by output voltage terminal VDD 120. Transistor QCP5A 190 is coupled between terminal VC14 188 and the output voltage terminal VDD 120, and has a control terminal coupled to the output of gate driver 191. Gate driver 191 is powered by VC13 174, and is referenced to terminal VC14 188.

Output voltage terminal VDD 120 provides power to gate driver 144 for transistor QPC6A 142 and to gate driver 194 for transistor QPC2A 192. The voltage across gate driver 172 for transistor QCP3A 170 is powered by terminal VC11 134 and terminal VC12 140. The voltage across gate driver 191 for transistor QCP5A is powered by terminal VC13 174 and terminal VC14 188. Transistors QCP8A 126 and QCP4A 168 require a gate drive voltage higher than VDD for control, so a voltage of 2*VDD is used to charge the capacitor powering VCDRV12 124. This voltage is provided by either terminal VC13 174 when operating in 3:1 charge pump mode or by terminal VC11 134 when operating in 2:1 charge pump mode. The voltage at terminal VC13 174 is 2*VDD when operating in 3:1 charge pump mode, so terminal VC13 174 is used to power gate driver 164 for transistor QCP4A 168.

The operation of single-phase boot capacitor charge circuit 600 is similar to the operation of phase A 196 of dual-phase charge pump circuit 400, but with one phase signal instead of two complementary phase signals. However, when terminal VC11 134 is connected to the output voltage terminal VDD 120, a voltage of 2*VDD is not available to power gate driver 132 for transistor QCP1A 128 because there is no complementary phase. For this reason, an auxiliary charge pump circuit that operates at a higher frequency is added to boost the voltage at terminal VC11 134 higher than VDD for driving boost capacitor CBST11 528.

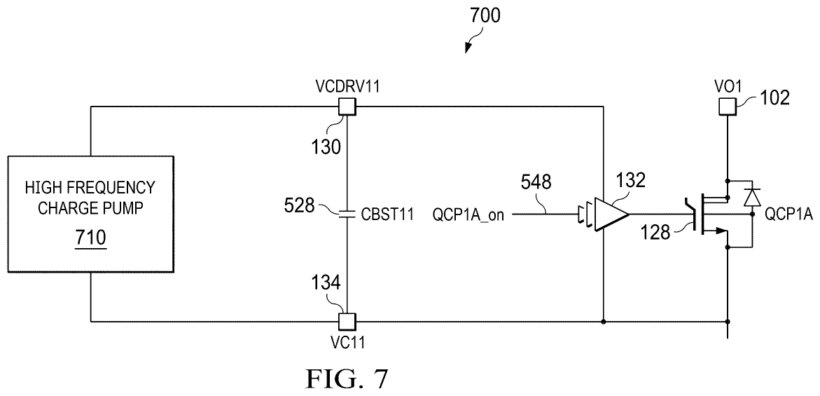

FIG. 7 shows a schematic diagram for an example auxiliary charge pump circuit 700 useful in single-phase boot capacitor charge circuits. High frequency charge pump 710 is coupled between VCDRV11 130 and terminal VC11 134. Capacitor CBST11 528 is coupled between VCDRV11 130 and terminal VC11 134. Gate driver 132 receives the signal QCP1A_on 548 at its input. Transistor QCP1A 128 is coupled between V01 102 and terminal VC11 134, and has a control terminal coupled to the output of gate driver 132.

High frequency charge pump 710 is a 2:1 charge pump circuit that operates at a higher frequency. High frequency charge pump 710 is a relatively low power charge pump, so it has a relatively smaller capacitor than may be found in some 2:1 charge pump circuits. Due to the use of a relatively smaller capacitor, high frequency charge pump circuit 710 has to run at a higher frequency.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A charge pump circuit, comprising:
a first phase circuit having a first power input and a first power output, wherein the first phase circuit is activated during a first operational cycle and inactivated during a second operational cycle;
a second phase circuit having a second power input and a second power output, wherein the second power output is coupled to the first power output, and the second phase circuit is activated during the second operational cycle and inactivated during the first operational cycle;
a first switch having first and second switch terminals and a first switch control terminal, wherein the first switch is configured to be closed in response to the first phase circuit being activated and a first charge pump mode being selected;
a second switch having third and fourth switch terminals and a second switch control terminal, wherein the fourth switch terminal is coupled to the second switch terminal, and the second switch is configured to be closed in response to the first phase circuit being activated and a second charge pump mode being selected;
a third switch having fifth and sixth switch terminals and a third switch control terminal, wherein the third switch is configured to be closed in response to the second phase circuit being activated and the first charge pump mode being selected; and
a fourth switch having seventh and eighth switch terminals and a fourth switch control terminal, wherein the eighth switch terminal is coupled to the sixth switch terminal, and the fourth switch is configured to be closed in response to the second phase circuit being activated and the second charge pump mode being selected.

2. The charge pump circuit of claim 1, further comprising:
a first gate driver circuit having a first gate driver input, a first gate driver output, a first supply voltage terminal, and a first supply reference terminal, wherein the first supply voltage terminal is coupled to the second and fourth switch terminals; and
a second gate driver circuit having a second gate driver input, a second gate driver output, a second supply voltage terminal, and a second supply reference terminal, wherein the second supply voltage terminal is coupled to the sixth and eighth switch terminals, and the second supply reference terminal is coupled to the first power output.

3. The charge pump circuit of claim 2, further comprising:
a first capacitor coupled between the first supply voltage terminal and the first supply reference terminal; and
a second capacitor coupled between the second supply voltage terminal and the second supply reference terminal.

4. The charge pump circuit of claim 2, wherein:
the first phase circuit includes a first transistor coupled between the first power input and the first supply reference terminal, and having a first transistor control terminal coupled to the first gate driver output; and
the second phase circuit includes a second transistor coupled between the first supply reference terminal and the first power output, and having a second transistor control terminal coupled to the second gate driver output.

5. The charge pump circuit of claim 4, further comprising:
a third gate driver circuit having a third gate driver input, a third gate driver output, a third supply voltage terminal, and a third supply reference terminal, wherein the third supply voltage terminal is coupled to the sixth and eighth switch terminals, and the third supply reference terminal is coupled to the first power output; and
a third transistor coupled between an internal voltage terminal and the first power output, and having a third control terminal coupled to the third gate driver output.

6. The charge pump circuit of claim 1, wherein the first charge pump mode is a 3:1 charge pump mode, and the second charge pump mode is a 2:1 charge pump mode.

7. The charge pump circuit of claim 1, wherein the charge pump circuit is configurable to switch from operating in the first charge pump mode to the second charge pump mode while the charge pump circuit is powered up.

8. The charge pump circuit of claim 7, further comprising:
a first logic circuit having first, second and third logic inputs and a first logic output, wherein the first logic input receives a first signal indicating the charge pump circuit is operating in the second operational cycle, the second logic input receives a second signal that selects the first charge pump mode, the third logic input receives a third signal that indicates the charge pump circuit is operating in the first operational cycle, and the first logic output is coupled to the first switch control terminal; and
a second logic circuit having fourth, fifth and sixth logic inputs and a second logic output, wherein the fourth logic input receives the third signal that indicates the charge pump circuit is operating in the first operational cycle, the fifth logic input receives a fourth signal that selects the second charge pump mode, the sixth logic input receives a fifth signal that indicates the charge pump circuit is operating in the second operational cycle, and the second logic output is coupled to the second switch control terminal.

9. The charge pump circuit of claim 8, further comprising:
a third logic circuit having seventh and eighth logic inputs and a third logic output, wherein the seventh logic input receives the first signal indicating the charge pump circuit is operating in the second operational cycle, the eighth logic input receives the second signal that selects the first charge pump mode, and the third logic output is coupled to the third switch control terminal; and
a fourth logic circuit having ninth and tenth logic inputs and a fourth logic output, wherein the ninth logic input receives the fourth signal that selects the second charge pump mode, the tenth logic input receives the fifth signal indicating the charge pump circuit is operating in the second operational cycle, and the fourth logic output is coupled to the fourth switch control terminal.

10. The charge pump circuit of claim 5, wherein the first, second and third transistors are each field effect transistors (FETs).

11. A two-phase charge pump circuit, comprising:
a first switch having first and second switch terminals and a first switch control terminal, wherein the first switch is configured to be closed in response to a first operational phase being selected and a first charge pump mode being selected;
a second switch having third and fourth switch terminals and a second switch control terminal, wherein the fourth switch terminal is coupled to the second switch terminal, and the second switch is configured to be closed in response to the first operational phase being selected and a second charge pump mode being selected;
a third switch having fifth and sixth switch terminals and a third switch control terminal, wherein the third switch is configured to be closed in response to a second operational phase being selected and the first charge pump mode being selected; and
a fourth switch having seventh and eighth switch terminals and a fourth switch control terminal, wherein the eighth switch terminal is coupled to the sixth switch terminal, and the fourth switch is configured to be closed in response to the second operational phase being selected and the second charge pump mode being selected.

12. The two-phase charge pump circuit of claim 11, further comprising:
a first gate driver circuit having a first gate driver input, a first gate driver output, a first supply voltage terminal, and a first supply reference terminal, wherein the first supply voltage terminal is coupled to the second and fourth switch terminals; and
a second gate driver circuit having a second gate driver input, a second gate driver output, a second supply voltage terminal, and a second supply reference terminal, wherein the second supply voltage terminal is coupled to the sixth and eighth switch terminals, and the second supply reference terminal is coupled to a power output terminal.

13. The two-phase charge pump circuit of claim 12, further comprising:
a first capacitor coupled between the first supply voltage terminal and the first supply reference terminal; and
a second capacitor coupled between the second supply voltage terminal and the second supply reference terminal.

14. The two-phase charge pump circuit of claim 13, further comprising:
a first phase circuit that includes a first transistor that is coupled between a first power input and the first supply reference terminal, and having a first transistor control terminal coupled to the first gate driver output; and
a second phase circuit that includes a second transistor coupled between the first supply reference terminal and the power output terminal, and having a second transistor control terminal coupled to the second gate driver output.

15. The two-phase charge pump circuit of claim 14, further comprising:
a third gate driver circuit having a third gate driver input, a third gate driver output, a third supply voltage terminal, and a third supply reference terminal, wherein the third supply voltage terminal is coupled to the sixth and eighth switch terminals, and the third supply reference terminal is coupled to the power output terminal; and
a third transistor coupled between an internal voltage terminal and the power output terminal, and having a third control terminal coupled to the third gate driver output.

16. The two-phase charge pump circuit of claim 11, wherein the first charge pump mode is a 3:1 charge pump mode, and the second charge pump mode is a 2:1 charge pump mode.

17. The two-phase charge pump circuit of claim 11, wherein the two-phase charge pump circuit is configurable to switch from operating in the first charge pump mode to the second charge pump mode while the two-phase charge pump circuit is powered up.

18. The two-phase charge pump circuit of claim 17, further comprising:
a first logic circuit having first, second and third logic inputs and a first logic output, wherein the first logic input receives a first signal indicating the two-phase charge pump circuit is operating in the second operational phase, the second logic input receives a second signal that selects the first charge pump mode, the third logic input receives a third signal that indicates the two-phase charge pump circuit is operating in the first operational phase, and the first logic output is coupled to the first switch control terminal; and
a second logic circuit having fourth, fifth and sixth logic inputs and a second logic output, wherein the fourth logic input receives the third signal that indicates the two-phase charge pump circuit is operating in the first operational phase, the fifth logic input receives a fourth signal that selects the second charge pump mode, the sixth logic input receives a fifth signal that indicates the two-phase charge pump circuit is operating in the second operational phase, and the second logic output is coupled to the second switch control terminal.

19. The two-phase charge pump circuit of claim 18, further comprising:
a third logic circuit having seventh and eighth logic inputs and a third logic output, wherein the seventh logic input receives the first signal indicating the two-phase charge pump circuit is operating in the second operational phase, the eighth logic input receives the second signal that selects the first charge pump mode, and the third logic output is coupled to the third switch control terminal; and
a fourth logic circuit having ninth and tenth logic inputs and a fourth logic output, wherein the ninth logic input receives the fourth signal that selects the second charge pump mode, the tenth logic input receives the fifth signal indicating the two-phase charge pump circuit is operating in the second operational phase, and the fourth logic output is coupled to the fourth switch control terminal.

20. The two-phase charge pump circuit of claim 15, wherein the first, second and third transistors are each field effect transistors (FETs).
